(19) United States
(12) Patent Application Publication
(10) Pub. No.: US 2026/0144279 A1
(43) Pub. Date: May 28, 2026

(54) SUSTAINABLE MEATS AND METHODS OF MAKING

(71) Applicant: Saferway Research Center, LLC, Westland, MI (US)

(72) Inventor: Aziz Chafic Awad, Westland, MI (US)

(73) Assignee: Saferway Research Center, LLC, Westland, MI (US)

(21) Appl. No.: 19/400,974

(22) Filed: Nov. 25, 2025

Related U.S. Application Data
(60) Provisional application No. 63/725,105, filed on Nov. 26, 2024.

(51) Int. Cl. A23L 13/60; A23D 9/007; A23D 9/04; A23L 13/40

(52) U.S. Cl. CPC A23L 13/67; A23D 9/007; A23D 9/04; A23L 13/424; A23L 13/426; A23L 13/428; A23L 13/48

(57) ABSTRACT

A composition and method are provided for producing sustainable ground meat and restructured steak products incorporating an animal fatty tissue substitute. The method includes homogenizing meat trimmings or ground meat without added water to release cellular components, combining the homogenized meat with one or more film-forming agents, fats or fat blends, flavor and color enhancers, and optional binders or bioactive compounds under controlled temperature, pH, and shearing conditions to form an animal fatty tissue substitute, and mixing the substitute with red meat, sustainable red-meat alternatives, or combinations thereof. The resulting compositions exhibit desirable fatty-tissue functionality and allow the production of ground meat products, patties, and restructured steaks, including cuts adhered using transglutaminase. The composition enables partial or substantial replacement of red meat with sustainable alternatives while maintaining flavor, texture, cook performance, and sensory attributes comparable to traditional meat products.

### CROSS-REFERENCE TO RELATED APPLICATIONS

This application claims the benefit of U.S. Provisional Patent Application No. 63/725,105 filed Nov. 26, 2024, titled “SUSTAINABLE MEATS AND METHODS OF MAKING,” hereby incorporated by reference in its entirety.

### FIELD

The present disclosure relates to methods and compositions to make sustainable ground meat (e.g., burgers, tacos . . . , etc.) and restructured steaks using a novel animal fatty tissue substitute, a crafted blend of meat, sustainable red meat alternatives and other essential sustainable ingredients that give the finished product an exceptional taste and functionality and would simultaneously have a positive impact on heart disease, strokes, climate change and natural resources depletion.

### BACKGROUND

Ground beef, mainly hamburgers, is undoubtedly the most consumed individual red meat product in the United States followed by steak. Americans consume about 10 billion pounds of ground beef per year. The average American eats three hamburgers every week—nearly 50 billion burgers per year and about half of this is consumed in restaurants. The versatility, taste, price and convenience of ground beef have contributed to its popularity. Unfortunately, along with its high level of consumption, ground beef has also been a major contributor of artery clogging saturated fat and calories to the American diet and it is one of the largest drivers of important environmental impacts such as greenhouse gases emissions (GHG), land use, water consumption, biodiversity and ecosystem function to name just some salient components.

For health and environmental reasons, there has been a trend to eliminate or reduce the consumption of red meat. According to an article from Mckinsey Quarterly (April 2020), titled “Climate math: What a 1.5-degree pathway would take,” the entirety of which is incorporated herein by reference, to avert the worst environmental impacts, it is estimated that each person on earth, on average, will need to cut by over half the percentage of protein they are projected to get from ruminant animals, mainly beef, by 2050. Companies and institutions have been rolling out strategies and approaches to address the environmental impacts of animals including better farming practices, reduction of food loss and waste, cultivating cell-based meat using actual animal cells and introduction of ultra-processed meatless meat used to make burger alternatives and other alternative meat products, i.e., “meat” products without actual meat present. Disappointing repeat purchases of meatless meat after trial are a key contributor to the market challenges. The eating experience is why many consumers are not repeating purchases. Consumers say their taste, texture, and flavor come up short in terms of juiciness and fatty mouthfeel, and lack of sustained springy and bouncy texture during chew down. With meatless meat, a choice based on environmental benefits alone is not enough; taste, nutritional profile and price are very important factors too. Cultivated meat is expensive and so challenging to scale it up for commercial production.

To avert the worst health impacts, meat producers and animal scientists have responded to this consumer demand by breeding animals with lower fat deposition and with leaner cuts of meat. Meat processors and researchers have also investigated, developed, and merchandised a range of low-fat meat products and meat analogs.

U.S. Pat. No. 5,230,913 is directed to mixtures comprising fat-insoluble, inorganic particulates and a surface layer of a fatty material are employed in edible compositions as low calorie fat substitutes. The fatty material is any edible lipid, including triglycerides, fatty acids, monoglycerides, diglycerides, and other fat-like materials including sucrose polyesters.

U.S. Pat. No. 5,082,678 is directed to a method for removing fat from a meat patty by heating the meat patty on both sides to a temperature sufficient to cause fat contained in the meat patty to liquefy, and then applying pressure to the meat patty sufficient to cause at least a portion of the liquefied fat contained in the meat patty to be exuded therefrom.

U.S. Pat. No. 6,149,962 is directed to a gel composition of water, substantially linear polymeric monosaccharide and insoluble material exhibiting exceptional gel strength, thermal stability and organoleptic properties that may be utilized as a fat mimetic in food products.

U.S. Pat. No. 3,922,352 is directed to a juicy sausage analog and its method of preparation. The sausage analog has at least three distinct phases: a continuous gel phase, a substantially discontinuous fat phase, and a discontinuous chewy proteinaceous phase. The resulting coarsely chopped blend is formed into a substantially cohesive sausage analog by coagulating the continuous gel phase precursor. The resulting coarsely chopped blend is formed into a substantially cohesive sausage analog by coagulating the continuous gel phase precursor.

U.S. Pat. No. 5,080,921 is directed to a low-calorie fat substitute having a continuous aqueous phase containing carbohydrate and protein and a dispersed phase containing protein and fat.

U.S. Pat. No. 5,654,028 is directed to a low-calorie meat product comprising a mixture having comminuted lean meat and a vegetable fat replacement ingredient comprising dietary fiber and starch.

U.S. Pat. No. 4,735,819 is directed to reduced calorie sausages having 40-90% of lean meat and 2-35% of cooked rice and having a fat content in the range of 4-35% by weight.

U.S. Pat. No. 3,748,148 is directed to a method of producing sausages with a reduced content of cholesterol in which 20-30% Brazil nuts are admixed to lean meats as 20 a substitute for animal fat. The aims of this disclosure is to provide sausages with a reduced animal fat (including cholesterol) content.

U.S. Pat. No. 4,844,922 is directed to a low-fat food with decreased amounts of animal fat or other types of fat containing a hot-melt type gal dispersed in the food tissue, wherein the amount of the gel to the food tissue at temperature below the melting point of the gel is in the range of about 1 to about 25 weight percent.

U.S. Pat. No. 4,904,496 is directed to a low-fat emulsion-type sausage products which includes a continuous phase of heat-set meat emulsion and a discontinuous phase of particles of a water in oil emulsion, the water in oil emulsion having edible fat as a continuous phase and an aqueous gelatin solution as its discontinuous phase.

U.S. Pat. No. 4,504,515 is directed to the preparation of low-fat meat products by combining high levels of skimmed milk or whole milk with comminuted lean meat.

U.S. Pat. No. 5,213,829 is directed to reduced cholesterol/saturated fat content meat products which are realized by in part substituting for natural fatty an artificial fatty based on an emulsion of: (a) blood plasma, preferably from the same species of animal as the meat from which the product is made, and (b) cholesterol free or low cholesterol fats and oils which may also be free of saturation or have a low degree of saturation.

U.S. Pat. No. 4,984,709 is directed to a method for making a reduced fat foodstuff entails replacing at least a portion of the fat and/or oil in the foodstuff with an aqueous dispersion of a hydroxypropylated starch having a degree of substitution of above 0.04 and an apparent amylose content of about 40%.

U.S. Pat. No. 4,980,185 is directed to a process that employs heated unsaturated oil to solubilize the saturated fat and cholesterol of fragmented meat and then employs an aqueous fluid to separate and remove the extracting oil from the oil processed meat. It further provides for meat having markedly reduced saturated fat, reduced total fat, and reduced cholesterol content; an aqueous meat flavoring and stock agent; and an oil containing concentrated amounts of cholesterol and saturated fat which may be employed for food in which cholesterol and saturated fat are not a concern or for non-food uses.

U.S. Pat. No. 3,658,550 is directed to a method for producing artificial fatty tissue material which is capable of being cooked itself or incorporated into simulated meat products to give the appearance and cooking behavior of natural meat products as well as impart a natural fatty flavor to the simulated meat product. The artificial fatty tissue is produced by reacting an aqueous solution of an alkali salt of alginic acid and a retarding agent with a fat dispersion of an alkaline earth metal salt to form an alginate gel matrix with the fat entrapped therein in small discrete droplets or globules, which are then slowly released by rupture of the walls enclosing these droplets during cooking to slowly baste the simulated meat as well as be somewhat retained within the gel matrix to impart a natural juicy taste to the simulated meat product.

U.S. Pat. No. 4,778,682 is directed to a method for lowering fat and cholesterol levels in meat including the steps of (a) exposing a thin layer of meat to ultraviolet light, (b) comminuting the meat in a chilled bowl with the addition of a quantity of iced water, edible acid, salt and food phosphates until a quantity of fat and cholesterol separate from the meat emulsion and adhere to the inner surface of the cold bowl. It also relates to a meat product free of added carbohydrates, artificial colorings and artificial preservatives wherein the fat portion is reduced 1-2% and the cholesterol portion is reduced by 10-60% from the levels present in the trimmed meat.

U.S. Pat. No. 5,576,047 is directed to a method and system for producing low fat ground meat. The method relates to a method of cooking raw ground meat so as to form a mixture that includes cooked ground meat, liquified fat and broth. Hot water is added to the mixture in an amount sufficient to cause a significant percentage of the liquified fat to float above the surface of the cooked meat mixture. The liquified fat layer is then removed. Subsequently, broth and water are also removed such that a cooked, low fat, chunky ground meat product results.

U.S. Pat. No. 5,650,187 is directed to a process for making a low-fat meat product includes grinding meat having less than 50% fat to reduce the meat to a small particle size. The meat is then heated to a target temperature less than 100° C., which is hot enough to melt the fat and low enough not to denature the meat. The meat is then placed in a centrifuge and subject to centrifugal separation, thereby making a low-fat meat product and an oil product. The low-fat meat is removed from the centrifuge and chilled and the oil product is removed and may later be subject to a polishing operation.

U.S. Pat. No. 5,382,444 is directed to a process for dramatically reducing the fat content while retaining the desirable functionality of the unprocessed meat sources. The fat-containing meat trimmings or the like are comminuted, heated and centrifuged under specific processing conditions in order to provide unformulated raw reduced fat meat having a fat content of not greater than on the order of about ten percent by weight while having excellent functionality.

U.S. Pat. No. 5,167,977 is directed to the reduction of the fat content of fat-containing meat by comminuting a frozen portion of the meat, thereby obtaining substantially discrete frozen meat particles and substantially discrete frozen fat particles. The particles are then mechanically separated into a substantially meat particle phase and a substantially fat particle phase.

U.S. Pat. No. 5,514,396 describes the exposure of raw meats to electromagnetic radiation of suitable frequencies generated, at suitable rates, expressed in Joules per second, to form a meat juice containing fat and nutrients. The heated meat is separated from the meat juice, the meat juice is separated into a fat layer and an aqueous layer containing nutrients, the aqueous layer is added to the previously heated meat to form a mixture, and the mixture is heated to allow the meats to absorb the aqueous layer to produce low fat meat products.

U.S. Pat. No. 6,497,915 is directed to a food ingredient, including a heat-set whey protein gel and a polysaccharide hydrocolloid which is present in an amount sufficient to influence the structure and texture of the gel, and a process for the preparation of the food ingredient.

U.S. Pat. No. 3,102,031 is directed to a food product made from inexpensive sources of vegetable protein, of which wheat gluten and soybean flour are preferred materials. The product is highly nutritious and is capable of simulating not only the flavor and texture of cooked meat but also its savory appearance.

U.S. Pat. No. 2,721,142 is directed to a meat-coating composition and process. The disclosure may be useful in providing a coating for frozen cuts of meat and especially for cuts of meat that are boned, rolled and tied. The coating has been used with especially good results on frozen veal cuts which are boned, rolled and tied, that is, on rolled veal roasts.

U.S. Pat. No. 3,658,550 is directed to a method of producing an artificial fatty tissue for use in simulated or artificial meat products. The artificial fatty tissue is produced by reacting an aqueous solution of an alkali salt of alginic acid and a retarding agent with a fat dispersion of an alkaline earth metal salt to form an alginate gel matrix with the fat entrapped therein in small discrete droplets or globules, which are then slowly released by rupture of the walls enclosing these droplets during cooking to slowly baste the simulated meat as well as be somewhat retained within the gel matrix to impart a natural juicy taste to the simulated meat product.

U.S. Pat. No. 5,232,722 is directed to a fat substituted for meat food which is added to processed food of minced meat and the like. The disclosure provides a fat substitute for meat food, which includes a gelling material having whey protein concentrate and a casein protein.

Despite these efforts, many exhibited various limitations or are overly complex. Accordingly, a need remains for providing a process to make an animal fatty tissue substitute with a healthy nutritional profile and natural adipose tissue-like functional properties during both cooking and eating. A need also remains for determining proportion between red meat and sustainable red meat alternatives in a final ground meat product or restructured steak having animal fatty tissue substitute to achieve one or more objectives including reduction in greenhouse gases emissions (GHG), land use, water consumption while maintaining the nutritional benefits and sensory attributes of a finished burger product and restructured steak. Other specific objects and advantages will appear as the specification proceeds.

### SUMMARY

The present disclosure relates to compositions and methods for producing an animal fatty tissue substitute and for incorporating that substitute into sustainable ground meat or restructured steak products. In certain aspects, the present disclosure provides a composition including an animal fatty tissue substitute formed from a homogenized meat or meat blend without added water combined with one or more film-forming agents, fats or fat blends, flavor and color enhancers, and optional binders or bioactive compounds. The homogenized meat or meat blend may be present in the composition in an amount of 3-95 wt. %, the film-forming agents may be present in an amount of 0.1-30 wt. %, the fats or fat blends may be present in an amount of 1-50 wt. %, and the flavor and color enhancers may be present in an amount of 0.001-10 wt. %. The resulting composition defines functional properties resulting from the conjoint effect of the component concentrations as well as pH, temperature, and shearing during formation. Optional elements of the composition may include proteinaceous binders, polysaccharide binders, fruits, vegetables, mushrooms, and bioactive compounds such as preservatives, vitamins, antioxidants, and phytochemicals. The film-forming agents may include materials such as gelatin, carrageenan, whey protein, caseinates, alginate, lecithin, plant proteins, and partially gelatinized collagen. The fats or fat blends may include vegetable oils, animal fats, omega-3 fatty acids, and synthetic lipids. The composition may further include specific color enhancers (e.g., annatto, beet powder, paprika oleoresin, fruit or vegetable extracts) and flavor enhancers such as hydrolyzed vegetable protein, meat flavorings, smoke flavor, spices, salt, and related compounds.

The present disclosure also provides a method of making an animal fatty tissue substitute. The method includes homogenizing meat trimmings or ground meat without added water to break down structure and release cellular components to form a meat or meat blend. The method further includes homogenizing this material with film-forming agents, fats or fat blends, flavor and color enhancers, and optional binders or bioactive compounds under vigorous shearing at a temperature below 10° C. and a pH of 3.5-10.5 to form an animal fatty tissue substitute that is devoid of added water. The resulting substitute may contain bioactive compounds, cereal or non-cereal proteinaceous binders, polysaccharide binders, and a wide range of vegetable-, fruit-, nut-, grain-, or legume-derived components. The film-forming agents, fats, proteinaceous binders, and polysaccharide binders may be selected from the materials identified in the composition claims, including gelatin, carrageenan, whey protein, plant proteins, partially gelatinized collagen, vegetable oils, animal fats, milk solids, egg albumin, plant proteins, maltodextrin, gums, and alginates. The substitute yields properties dependent on the conjoint effect of the fat blend, meat blend, film-forming agents, flavoring components, temperature, pH, and shearing.

In additional aspects, the present disclosure relates to methods of producing sustainable ground meat or restructured steak products. These methods include providing a proportion of red meat or sustainable red-meat alternatives, incorporating the animal fatty tissue substitute formed according to the above method, and shaping the finished product into patties or bulk ground-meat formats. Restructured steak products may be formed using a transglutaminase enzyme to adhere the components. The red-meat component may include beef, veal, lamb, mutton, bison, pork, venison, and combinations thereof. The sustainable red-meat alternatives may include white meats such as chicken, turkey, duck, goose, fish, rabbit, and fowl; plant-derived proteins such as soy, pea, gluten, legumes, nuts, and grains; or fruits, vegetables, and fungi, including green banana, apple peel, legumes such as peas or lentils, nuts such as almonds or walnuts, grains such as quinoa or oats, and mushrooms. The relative proportions of red meat to sustainable red-meat alternatives may vary from entirely red meat (1:0) to entirely sustainable alternatives (0:1), including combinations such as 0.1:1 to 1:0.1 and preferably about 1:1. The fatty tissue substitute may be combined with these components at weight ratios of 0.01:1 to 1:1.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

To easily identify the discussion of any particular element or act, the most significant digit or digits in a reference number refer to the figure number in which that element is first introduced.

FIG. 1 is a side-by-side chart comparison of greenhouse gases emission data per serving of ground meat (hamburger) as reported in a publication by the Center for Sustainable Systems of the University of Michigan titled “Carbon Footprint,” (hereinafter “Carbon Footprint”), the entirety of which is incorporated herein by reference, and a bulletin 1382 by the University of Georgia Extension titled “Global Warming: How Does It Relate to Poultry,” the entirety of which is incorporated herein by reference, ((hereinafter “Global Warming”), and emission data resulting from a meat product according to the present disclosure (i.e., “novel patties”).

FIG. 2 is a side-by-side chart comparison of environmental data reported by the Proceedings of the National Academy of Sciences (PNAS, Vol. 111, no. 33) titled “Land, irrigation water, greenhouse gas, and reactive nitrogen burdens of meat, eggs, and dairy production in the United States,” the entirety of which is incorporated herein by reference, ((hereinafter “Land Irrigation”), and a meat product according to the present disclosure (i.e., “novel patties”).

FIG. 3 is a side-by-side chart comparison of a meat product produced according to the present disclosure and untreated hamburger made with 100% ground beef having 80% lean meat and 20% fat.

### DETAILED DESCRIPTION

The present disclosure provides for a process to make an animal fatty tissue substitute with a healthy nutritional profile and natural adipose tissue-like functional properties during both cooking and eating.

The present disclosure further provides for determining an optimal proportion between red meat and sustainable red meat alternatives in a final ground meat product or restructured steak containing an animal fatty tissue substitute to achieve several objectives including reduction in greenhouse gases emissions (GHG), land use, water consumption while maintaining the nutritional benefits and sensory attributes of a finished burger product and restructured steak. Other specific objects and advantages will appear as the specification proceeds.

There are a number of issues to be resolved in order to produce low fat ground meat and burgers that are acceptable to a given market, mainly the lack of functionality of natural adipose tissue in animals when used at low levels. For example, reduction of fat content below 20% in burgers can lead to unacceptable product texture, flavor, and appearance. Total replacement of fat with water produces unacceptably soft products with increased purge loss. Direct replacement of fat with non-meat ingredients, particularly proteins, starches and gums, is an attractive approach in low fat meat products; however, the biggest challenge associated with these replacers is to maintain the functional properties of the product while imparting fat-like properties. For example, the formulations described in the prior art, which are basically intended to be used with meat analogs, hold small amount of fat and may modestly improve the quality of meat-like products having a deficiency of fat, but they do not provide a juicy, smooth melt-down simulating that of natural animal adipose tissue especially when mixed with natural fresh lean meat to make burgers, sausage, hot dogs or bologna. They have some distinct disadvantages in that the fat bleeds easily when the artificial meat is cooked at a 50° C. high temperature, thus leaving little fat behind to provide a desirable flavor for the artificial meat product. Burgers, sausage or hot dogs made according to the formulations found in the prior art are either very dry and have a liver like texture or very juicy but lack cohesiveness and have a pudding like texture.

A process according to the present disclosure is provided to make a healthy and desirable animal fatty tissue substitute. It has been developed and unexpectedly found to closely resemble the natural animal adipose tissue in that it incorporates a special fat blend within its matrix in small discrete droplets or globules in a manner approximating the storage of fat in connective natural animal tissue, and thus has the ability to rupture the walls enclosing the fat on cooking in the same manner as natural animal adipose tissue cells and provides a slow basting to the ground meat (e.g., burgers) and restructured steaks final products. It can further retain a large percentage of fat within the unruptured matrix to provide a pleasurable taste and consistency that may be associated with natural fatty meat products.

It is another object of the present disclosure to develop an animal fatty tissue substitute that has overall better nutritional properties than natural animal adipose tissue, and especially suitable for preparing low fat and low-calorie dietetic ground meat (e.g., burgers, tacos . . . , etc.), restructured steaks, hot dogs, salami, pepperoni, and bologna and others.

It is further an object of the present disclosure to enhance the functional characteristics of natural adipose tissue when it is naturally held in contact with red meat-such as meat trimmings and ground meat with about 80% lean and 20% fat or about 73% lean and 27% fat and desirable other ratios. By applying the process outlined in this disclosure, the natural adipose tissue that is naturally held in contact with red meat undergoes a significant improvement in juiciness, mouthfeel, and texture.

It is further an object of the present disclosure to develop an animal fatty tissue substitute that has overall better functionality than the natural animal adipose tissue by virtue of a specific combination of a unique fat blend, a carefully crafted meat blend, film-forming agents, polysaccharides, precise pH adjustment, and vigorous shearing force that form a synergistic positive effect on the quality of the final product such as good oil release, smooth mouthfeel, moisture retention, good texture and natural animal adipose tissue like melt upon mastication.

Another object of the present disclosure is to provide a product where the components used can be made to adhere or react with each other by homogenization to form an animal fatty tissue substitute with inseparable ingredients in a soft solid state. Homogenization is carried out by treating blended ingredients by cutting, grinding, emulsifying or another way so that the mixture forms a soft solid.

Another object of the present disclosure is to provide a mixture devoid of added water. Added water is very detrimental to the functional property of the novel animal fatty tissue substitute and the quality of the final product made with it. Surprisingly, the endogenous water of the meat itself was unexpectedly functional enough, in the context of the present disclosure, to hydrate and solubilize dry film-forming agents and binders.

Still another object of the present disclosure is to determine optimal proportions between red meat and sustainable red meat alternatives in a final ground meat product (e.g., burgers) or restructured steaks containing the novel animal fatty tissue substitute. This precise ratio aims to achieve several critical objectives: (1) reducing greenhouse gas emissions (GHG); (2) land use efficiency; (3) water conservation; (4) nutritional benefits and (5) sensory attributes. These objectives were accomplished by integrating the novel animal fatty tissue substitute of the present disclosure into a formulation to create a harmonious balance, aligning environmental responsibility and health benefits with consumer satisfaction.

### Process Development:

In naturally occurring meats, fat is held in contact with red meat tissue as globules contained within a collagen-based cellular network called adipose tissue. During cooking, the fat within the adipose tissue is melted and released from the tissue as the cellular structure ruptures. The cooked natural animal adipose tissue adds a desirable and pleasing juiciness and smoothness to ground beef, sausage and hot dogs and the adipose tissue itself will have a melt-in-the-mouth characteristic, which until the present disclosure, has been exclusively the characteristic of natural animal adipose tissue.

The process for preparing a novel animal fatty tissue substitute according to the present disclosure employs a series of steps and a set of conditions effective to provide fat globules of desired size and uniformity, and a suitably functional matrix phase, which together will result in an organoleptically pleasing end product having the desired natural animal adipose tissue simulating properties.

The present disclosure provides methods and compositions to make sustainable ground meat (e.g., burgers, tacos . . . , etc.) and restructured steaks that would simultaneously have a positive impact on heart disease, strokes, climate change and natural resource depletion using the optimal proportion of red meat and sustainable red meat alternatives (e.g., white meat, . . . , etc.) and other essential ingredients and incorporating the novel animal fatty tissue substitute which is devoid of added water and including:
a. homogenizing the meat trimmings or ground meat without adding water to break down meat structure and release cellular components from animal cells. These components are then homogenized again with other ingredients used to make them adhere or interact with each other to form the novel animal fatty tissue substitute which property is a function of a conjoint effect of total weight concentrations (% w/w) of the fat blend, carefully crafted meat blend, film-forming agents, flavor and color enhancers, temperature, precise pH adjustment and vigorous shearing, wherein:
1. an amount of singular meat or meat blend is 3-95% w/w, preferably 40-80% w/w;
2. an amount of the film-forming agents is 0.1-30% w/w, preferably 1-10% w/w;
3. an amount of singular fat or fat blend is 1-50% w/w, preferably 5-40% w/w;
4. an amount of allowable enhancers such as flavor and color 0.001-10% w/w, preferably 0.1-3% w/w;
5. temperature is <10° C., preferably 1° C. to 3° C., and
6. pH is adjusted to 3.5 to 10.5 and preferably 4 to 8 and most preferably 5.4 to 6.2; food grade base or acid can be used to set the pH to a desired level;
b. optionally, edible bioactive compounds such preservatives, vitamins, antioxidants, phytochemicals may be added/incorporated in this composition to enhance its nutritional and medicinal properties;
c. optionally, a wide variety of known binders selected from among cereal and non-cereal type proteinaceous material, as well as from polysaccharides and the like may be added/incorporated in this composition to impart a desired firmness;
d. mixing the novel animal fatty tissue substitute with a singular meat or a blend of red meat and sustainable red meat alternatives at a weight ratio of 0.01:1 to 1:1, wherein the weight ratio of red meat to sustainable red meat alternatives can vary, including entirely red meat 1:0, entirely sustainable red meat alternatives 0:1, and any combination therebetween such as 0.1:1 to 1:0.1 and more preferably 1:1; and
e. shaping a finished ground meat product into patties using traditional burger molds or package in bulk for tacos and other ground meat applications; whereas a restructured steak can be adhered together using a Transglutaminase enzyme.

Meat products made with the novel animal fatty tissue substitute produced according to the teaching of the present disclosure have very desirable attributes such as juiciness, reduction of shrinkage and purge, and great flavor yet with fewer calories and less total and artery-clogging saturated fat than their traditional counterparts. The optimal proportion between red meat, sustainable red meat alternatives and the integration of the novel animal fatty tissue substitute into the formulation of the finished ground meat product or restructured steaks achieved several critical objectives including reduction in greenhouse gases emissions (GHG), land use, water consumption while maintaining great nutritional benefits and sensory experiences. The rationale for each step in the process is described below.

### Red Meat and Sustainable Red Meat Alternatives:

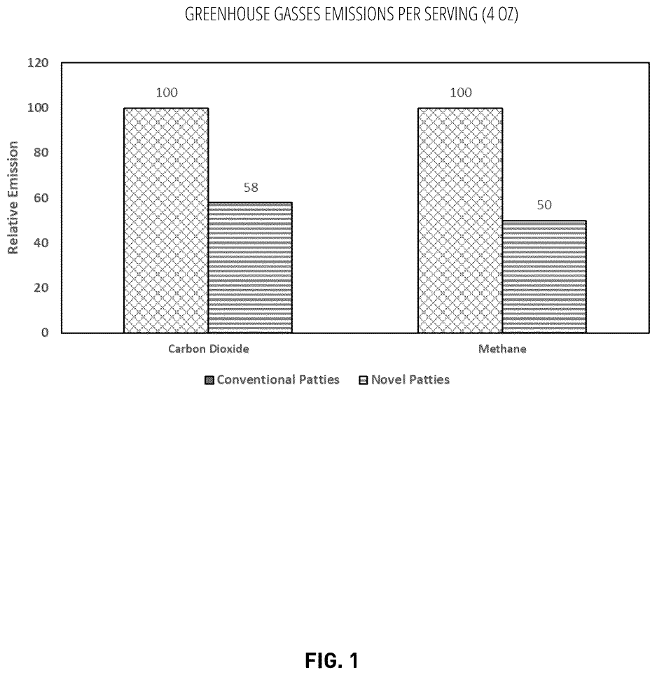

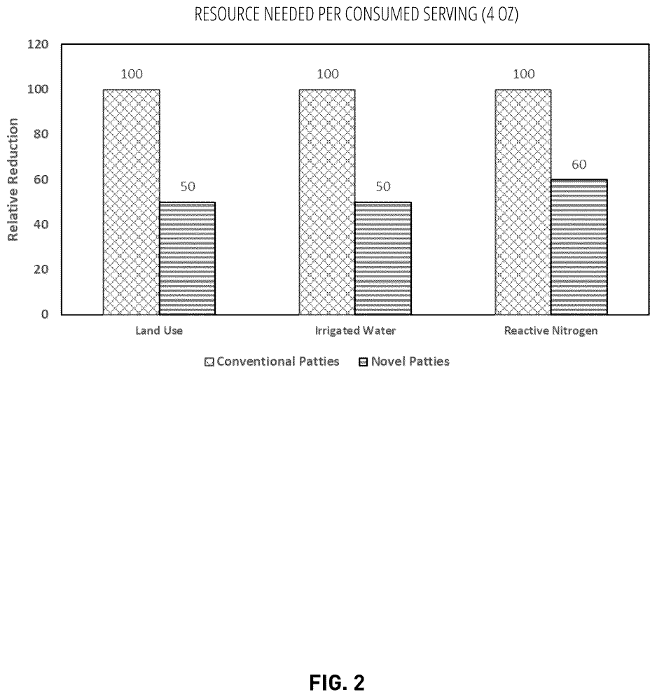

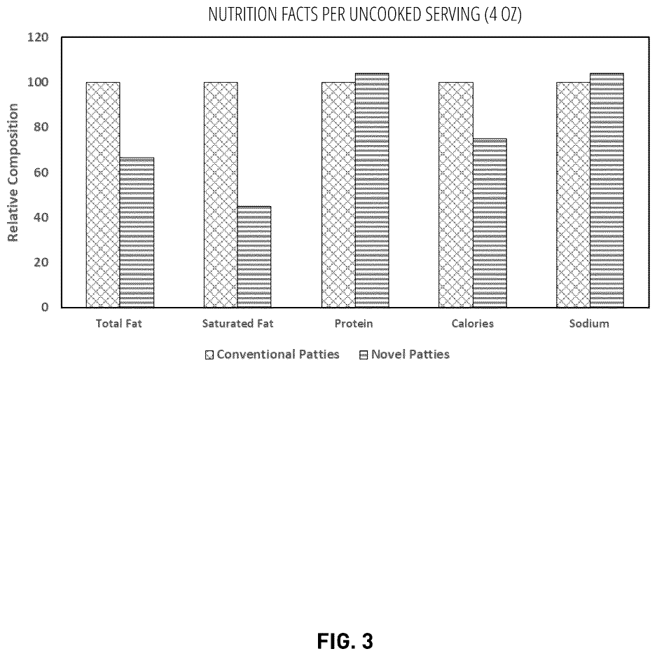

A goal of the present disclosure is to determine optimal proportions between red meat and sustainable red meat alternatives in the finished ground meat product and restructured steaks containing an novel animal fatty tissue substitute. The weight ratio of red meat to sustainable red meat alternatives can vary, including entirely red meat 1:0, entirely sustainable red meat alternatives 0:1, and any combination such as 0.1:1 to 1:0.1 and more preferably 1:1. This weight ratio aims to achieve several critical objectives:
a. Referring to FIG. 1, Reducing Greenhouse Gas Emissions (GHG): By fine-tuning the combination of red meat and sustainable red meat alternatives (e.g., white meat), the present disclosure is configured to reduce and/or minimize environmental impact associated with GHG emissions. In a side-by-side comparison based on the environmental data shown in the Carbon Footprint reference and the Global Warming reference, meat produced according to the present disclosure including the animal fatty tissue substitute of the present disclosure and a red to white meat weight ratio of 1:1, reduces emissions by over 45% in terms of CO₂ and methane gases compared to traditional 100% beef with 20% fat.
b. Referring to FIG. 2, Land Use Efficiency: Ratios of red meat and sustainable red meat alternatives (e.g., white meat) should lead to efficient land utilization, ensuring sustainable practices without compromising productivity. In a side-by-side comparison based on the environmental data of the Land Irrigation reference, meat produced according to the present disclosure including the novel animal fatty tissue substitute and a red to white meat weight ratio of 1:1 reduces land use and reactive nitrogen by over 40% compared to traditional 100% beef with 20% fat.
c. Still referring to FIG. 2, Water Conservation: The present disclosure creates a balance that conserves water resources while maintaining product quality. In a side-by-side comparison based on the environmental data of the Land Irrigation reference, meat produced according to the present disclosure including the novel animal fatty tissue substitute and a red to white meat weight ratio of 1:1 reduces irrigation water by over 45% compared to traditional 100% beef with 20% fat.
d. Referring to FIG. 3, Nutritional Benefits: Despite these adjustments, nutritional value of a finished ground meat product and restructured steak of the present disclosure can be improved as there was a major reduction in total and artery-clogging saturated fat and calories when compared to traditional ground beef; whereas protein level was increased. There is strong epidemiological evidence associating heart disease and stroke with excessive consumption of artery-clogging saturated fat and total caloric intake such as those found in traditional ground meat with 20% fat level. In a side-by-side comparison, meat produced according to the present disclosure including the novel animal fatty tissue substitute and a red to white meat weight ratio of 1:1 reduces total fat by 40%, saturated fat by over 54% and calories by 25% compared to traditional 100% beef with 20% fat.
e. Sensory Attributes: Equally important is preserving the sensory experience—flavor, texture, and overall appeal—of the finished burger product and restructured steaks.

All these objectives were accomplished by using a proportion of red meat to sustainable red meat alternatives and integrating the novel animal fatty tissue substitute of the present disclosure into the formulation to create a harmonious balance, aligning environmental responsibility and health benefits with consumer satisfaction. FIGS. 1-3 show the advantages provided by the present disclosure over traditional meat containing natural animal adipose tissues.

Research at the University of Michigan (Carbon Footprint) showed that the amount of CO₂ produced per 4 oz of beef meat is 6.61 lbs. If just 10% of the traditional ground beef consumed per year in the USA is replaced with ground meat produced according to the teaching of the present disclosure where the red meat to sustainable red meat alternatives (e.g., white meat) weight ratio is 1:1, there will be 11.2 billion lbs (˜5 million metric tons) less CO₂ emitted to the atmosphere or the equivalent of replacing 1.5 million internal combustion engine (ICE) cars per year with electric ones (See e.g., “How much emissions do electric cars produce?”, published Aug. 18, 2022, usafacts.org/articles, hereinafter “How much emissions,” the entirety of which is incorporated herein by reference). Moreover, based on the figures from peer reviewed study published in the Land Irrigation, 76 million m³ of irrigation water will be saved per year and 7 million hectares of land will be freed per year for other crops for just replacing 10% of the traditional ground beef consumed in the USA with ground meat produced according to the teaching of the present disclosure.

The present disclosure aims to utilize uncooked meat sourced from any animal or cultivated meat (lab-grown meat or cell-based meat) as the initial material for processing. This raw meat is an essential component of both the novel animal fatty tissue substitute and the final product, which encompasses ground meat or restructured steaks.

In an example, the animal meat may come from cultivated meat or any animal source including mammals, reptiles, fish and birds. Accordingly, red meats include, but are not limited to, beef, veal, and all meat products from cattle; lamb, mutton, bison and all meat products from sheep; pork, venison and all meat products from pigs and swine.

White meats may include, but are not limited to, chicken, turkey, duck, goose, fish, rabbit, and any kind of domestic or wild fowl. It is not required that the raw meat be only of one kind or obtained from only one source; to the contrary, many recipes and human needs require mixtures of different kinds of meat from various sources. Accordingly, neither the nature, source, type, or quality of meat is deemed to be a relevant or restrictive factor for purposes of practicing the present disclosure. On the other hand, the raw meat need not be fresh meat as such; the techniques of freezing, cold storage, salting, and other conventional means for preserving meat without cooking are all deemed to provide meat in a form which is useful for treatment by the present disclosure.

It is most desirable that the meat to be treated be in a fragmented form rather than in bulk or chunk form, although bulk or chunk forms can also be used without restriction. Fragmented meat provides a greater surface area and more effective means of access for the other ingredients of the present disclosure. In its most preferred form, the meat has actually been prepared in ground or minced form. Alternatively, however, the meat need not be completely pulverized but may be employed after chopping, shredding, cutting, grinding, piercing, crushing, and any other form which provides fragmented meat particles of varying sizes.

Sustainable alternatives to red meat that are suitable for use in the compositions of the present disclosure include, but not limited to:
a. Fish is an excellent source of protein and heart-healthy omega-3 fatty acids. Varieties like salmon, mackerel, and sardines are not only nutritious but also sustainable.
b. Poultry options include, but not limited to, Chicken, turkey, duck, goose, quail, pheasant, Cornish hen, guinea fowl are lean and versatile. They offer high-quality protein without the environmental footprint associated with red meat.
c. Beans (such as black beans, soybean, chickpeas, peas, lentils . . . , etc.) are not only protein-packed but also rich in fiber.
d. Plants derived proteins, including but not limited to soy, pea, gluten, . . . , etc. are great options too.
e. Nuts such as almonds, walnuts, cashews, pistachios, pecans, hazelnuts, macadamia nuts, Brazil nuts, and other nuts are protein-rich and provide healthy fats. They are great additions to the diet and contribute to sustainability.
f. Whole grains and/or their flours, including but not limited to quinoa, brown rice, whole wheat, oat, barley, . . . , etc. are excellent sources of protein. They also offer additional nutrients and contribute to sustainable eating.
g. Fruit and vegetables, may include but not limited to apple peels, green banana, cherries, pineapples, fruit puree, zucchini, cauliflowers . . . , etc.
h. Conventional and functional mushrooms can be used. They have a small environmental footprint compared to other protein sources. They require less water, land, and energy to grow.

### Fat:

The juiciness and mouthfeel of meat products created using the present disclosure are closely tied to the fat content and fat composition of the novel animal fatty tissue substitute. To achieve optimal results, it may be useful to use a fat that possesses a suitable composition and physical form. This fat should enhance the juiciness of the product without negatively impacting other physical attributes. In the context of this disclosure, a singular fat or a blend of fats combined with other ingredients strikes a harmonious equilibrium so that the resulting novel animal fatty tissue substitute exhibits characteristics similar to natural animal adipose tissue.

The fats and oils suitable for use in compositions of the present disclosure include but are not limited to omega-3 fatty acids, vegetable oils (olive oil, corn oil, safflower oil, canola oil, soybean oil, grape seed oil, peanut oil, cottonseed oil, cocoa butter and even the more saturated coconut oils), animal fats (beef fat, cod liver oil, butter oil, chicken fat, goose fat, duck fat, turkey fat, lard, sheep fat), synthetic lipids, and the like. Lipids such as high oleic derivatives, canola oil, sunflower and the like obtained from genetically modified sources can also be used. This listing of fats is by no means exhaustive, but merely exemplary of materials which may be readily employed by those skilled in the art.

A preferred blend of fat used in an example of the present disclosure may include 20 to 95% low melting point liquid vegetable oil (20-25° C.), 4 to 65% medium melting point fat (30-40° C.) and 1 to 15% high melting point fat (50 to 65° C.). Low melting point liquid vegetable oils include, but not limited to, corn, canola, soybean oil and the like or a mixture thereof. Medium melting point fats include, but not limited to, palm oil, lard, beef tallow and the like or a mixture thereof. High melting point fats include, but not limited to, fully hydrogenated vegetable or animal fat, palm kernel, palm stearine and the like or a mixture thereof. This particular fat blend gives the desired mouthfeel and has the proper melting characteristics and does not adversely affect the other physical properties of the novel animal fatty tissue substitute.

The quantity of fats and oils used in the present disclosure, whether singular or a blend, may vary from 1% to 50% by weight, preferably 5% to 40% by weight; and most preferably within the range of 15% to 30% by weight.

### Film-Forming Agents:

A combined effect of the components employed in this disclosure arises following homogenization within a matrix that creates a continuous film around the fat globules. This film formation is primarily attributed to the presence of film-forming agents. These film-forming agents also contribute to structural integrity and separation of fat globules during processing due to their inherent film-forming properties. However, it is crucial to note that these film-forming agents, when present into the final product, become unexpectedly even more soluble upon contact with the meat blend's natural endogenous water content released during cooking of the final product. This solubility results in a wetting and sliminess of the residue of the novel animal fatty tissue substitute remaining after chewing such that this residue creates a mouthfeel similar to natural adipose tissue's melt-in-the-mouth sensation.

Gelatin, carrageenan, milk whey protein, caseinates, alginate, lecithin, plant proteins and partially gelatinized collagen are among the preferred film-forming agents for their ability to create a smooth mouthfeel and a melting sensation in the mouth, while also providing some structural integrity to the matrix during processing. Of these agents, gelatin stands out as an effective choice. If needed, partial substitution of these preferred agents can be achieved using caseinate hydrolysates, cellulose derivatives (e.g., methyl cellulose, hydroxypropyl cellulose, carboxymethyl cellulose, . . . , etc.), mono- and diglycerides, cyclodextrins and gums. Partially gelatinized acid conditioned collagen can be employed with or in place of gelatin to provide a more cohesive and chewier characteristic to the end product while still providing the desired mouthfeel and melting characteristics. The amounts of film-forming agents should, however, be limited to those levels which do not adversely affect the unusually good mouthfeel and melting characteristics of the novel animal fatty tissue substitute of this disclosure. The quantity of the film-forming agents may vary from 0.1% by weight to 30% by weight, and most preferably within the range of 1 to 10% by weight.

### Binders:

A wide variety of known binders selected from among cereal and non-cereal type proteinaceous material, as well as from polysaccharides and the like may be incorporated in this composition to impart a desired firmness.

Herein the proteinaceous materials include, but not limited to, milk solids, egg albumin, blood albumin, red and white meat proteins and plant proteins (e.g., seeds, legumes, grains, nuts, fruit and vegetables) or mixtures thereof.

Polysaccharides, which may be of natural or synthetic origin, as for example maltodextrin, corn syrup, sodium carboxymethylcellulose, cyclodextrin, methyl and hydroxypropyl methylcellulose, xanthan gum, gum tragacanth, sodium alginate, calcium alginate, high and low methoxyl pectin, gum agar, gum karaya, gum Arabic, or any mixtures thereof. Also, monosaccharides such as dextrose and fructose may be used for this purpose. The novel animal fatty tissue substitute comprises at least from 0.01% by weight to 30% by weight, preferably within the range of 1 to 10% by weight and most preferably 0.1% to least 2% by weight of binding agents.

### Homogenization and Water:

This disclosure is based on the fact that the components used can be made to adhere or react with each other by homogenization to form the novel animal fatty tissue substitute with inseparable ingredients in a soft solid state. The mixture is devoid of added water. Added water is very detrimental to the functional property of the novel animal fatty tissue substitute. Added water does not give the novel animal fatty tissue substitute and the final product (e.g., ground meat and restructured steaks) of the present disclosure an acceptable texture, good oil release, smooth mouthfeel, and natural adipose tissue like melt upon mastication. Moreover, added water has a detrimental effect on sustaining the structural integrity of the novel animal fatty tissue substitute matrix leading to pudding-like texture that lacks cohesiveness. Surprisingly, the endogenous water of the meat itself was unexpectedly sufficient to hydrate and solubilize the dry film-forming agents and binders. Homogenization is carried out by treating the blended ingredients by cutting, grinding, emulsifying or another way so that the mixture forms a paste. Homogenization is optimally carried out at temperatures below 10° C., with a preference for the range of 1° C. to 3° C. The controlled temperatures ensure that the novel animal fatty tissue substitute remains stable, and spoilage is minimized. Temperatures higher than 10° C. are detrimental to the functionality of the novel animal fatty tissue substitute such as separation of its ingredients and accelerate spoilage. The homogenization time is 1 to 10 min, but preferably 2 to 4 min.

pH

The pH of a novel animal fatty tissue substitute can be adjusted to 3.5 to 10.5 and preferably 4 to 8 and most preferably 5.4 to 6.2; food grade base or acid can be used to set the pH to the desired level. The PH levels higher than 10.5 and lower than 3.5 can result in discoloration and bad flavor and texture. That is why it is desirable to maintain the right pH level as described in the present disclosure.

Food grade bases that can be used include, but are not limited to, potassium hydroxide, sodium bicarbonate, sodium carbonate, potassium bicarbonate, potassium carbonate, sodium hydroxide, phosphates, polyphosphates and any combination thereof. Moreover, food grade acids that can be used include, but are not limited to, citric acid, lactic acid, sorbic acid, phosphoric acid, ascorbic acid, hydrochloric acid and any combination thereof.

### Temperature

Working with raw meat within a specific cold temperature range <10° C., preferably 1° C. to 3° C., is crucial for homogenizing the meat effectively when blended with the other ingredients of the present disclosure. The use of cold temperatures in this process is essential for several reasons. Firstly, maintaining a cold environment helps prevent the spoilage of the novel animal fatty tissue substitute from germs, preserving its freshness and quality. Secondly, working within this temperature range minimizes losses of functionality of the novel animal fatty tissue substitute, ensuring that it retains its desired texture and properties. Additionally, cold temperatures prevent the undesirable phenomenon of “oiling off,” where fat separates from the novel animal fatty tissue substitute mixture during homogenization. Therefore, by utilizing cold temperatures <10° C., and more preferably 1° C. to 3° C., the homogenization process can be carried out efficiently while safeguarding the integrity and characteristics of the all the ingredients in the mixture.

### Flavors

Most any flavoring material commonly employed in meat can be employed in the novel animal fatty tissue substitute or the final products according to the present disclosure. Prominent among these materials are hydrolyzed vegetable protein, artificial and natural meat flavoring, beef stocks, smoke flavor, black pepper, white pepper, coriander, mace, nutmeg, rosemary, sugars, red pepper, sage, salt, sodium guanylate, monosodium glutamate, hydrolyzed soy protein, autolyzed yeast extract, disodium guanylate or inosinate and the like. The quantity may vary from 0.001% to 10% by weight, to preferably 0.1% to 3% by weight.

### Preservatives

Preservatives could play a crucial role in preserving the integrity and safety of the novel animal fatty tissue substitute and the final products. Preservatives serve several essential functions: (1) prevent spoilage from bacteria, molds, fungi, or yeast (antimicrobials); (2) slow or prevent changes in color, flavor, or texture; (3) delay rancidity (antioxidants); and (4) maintain freshness. Prominent among these materials are ascorbic acid, lactic acid, citric acid, sodium benzoate, calcium propionate, sodium erythorbate, sodium nitrite, calcium sorbate, potassium sorbate, BHA, BHT, EDTA, tocopherols (Vitamin E). The quantity may vary from 0.001% to 10% by weight, to preferably 0.1% to 3% by weight.

### Colors

Incorporating colors rectifies inherent color discrepancies, intensifies naturally occurring colors, and imparts color to sustainable red meat alternatives (e.g., white meat). It also serves to counteract color degradation caused by light, air, temperature fluctuations, moisture, and storage conditions. Prominent among these materials are FD&C Red No. 3 and 40, Citrus Red No. 2, annatto extract, soy leghemoglobin, animal hemoglobin including all hemoglobin-based products like frozen blood and others, beta-carotene, lycopene, grape skin extract, red beet extracts, red beet powder, paprika oleoresin, fruit and vegetable dry extracts. The quantity may vary from 0.001% to 10% by weight, to preferably 0.1% to 3% by weight.

The following examples are intended to promote a further understanding of the present disclosure. The compositions of the disclosure are illustrated by examples of specific formulations as described below without, however, being limited thereto. It is to be understood that these examples are provided by way of illustration only and that further useful formulations falling within the scope of the present disclosure may be readily produced by one skilled in the art without deviating from the scope of the disclosure.

### Example 1

A series of animal fatty tissue substitutes according to the present disclosure were prepared having the compositions indicated in Table 1. The steps involved in using meat were carried out at refrigeration temperature because raw meat is highly perishable. This means that the meat was kept and processed with other ingredients at a relatively low temperature, typically between 1° C. and 5° C., to prevent spoilage and bacterial growth. By maintaining a cold environment, the shelf life of the animal fatty tissue substitute can be extended and its safety for consumption ensured.

TABLE 1
Combination of Compositions of Different Constituents

| | Meat | Binders | Film-forming | Flavor | Color | Fat | pH | |
|---|---|---|---|---|---|---|---|---|
| Composition | (g) | (g) | Agents (g) | (g) | (g) | (g) | Adjuster | pH |
| 1 | 80 | 2 | 2 | 0.1 | 0.4 | 15.5 | 0 | 5.3 |
| 2 | 67 | 1 | 1 | 2 | 1 | 30 | 0 | 5.5 |
| 3 | 75 | 5 | 3 | 1 | 1 | 15 | 0 | 5.1 |
| 4 | 95 | 0.5 | 0.5 | 3 | 0 | 1 | q.s.* | 7.5 |
| 5 | 3 | 17 | 30 | 0 | 0 | 50 | q.s. | 10 |
| 6 | 40 | 30 | 10 | 10 | 0 | 10 | q.s. | 3.5 |
| 7 | 60 | 0.1 | 0.1 | 3 | 0.1 | 36.7 | q.s. | 6.1 |
| 8 | 70 | 0.3 | 1 | 2 | 10 | 16.7 | 0 | 5.8 |
| 11 | 50 | 0 | 1 | 2.5 | 4.5 | 43 | q.s. | 4 |

*q.s. to adjust pH to desired level

In each instance, the film-forming agents, binders, flavors, colors and other additives, collectively referred to as dry ingredients, were meticulously blended together without the addition of any water at all. The blending was carried out either manually using a whisk or utilizing an electric Kitchen Aid stand mixer (with a capacity of 5 quarts) for 3 minutes at speed 1 at room or refrigeration temperature. The dry mix is stable at room temperature, but it was stored at refrigeration temperature because it needs to match the low temperature of the meat it will be added to so that when mixed with the meat, it does not raise the meat's temperature.

Meat trimmings or ground meat were placed in a Vertical Cutter/Mixer equipped with twin stainless-steel knives. The Cutter/Mixer was operated at 3400 cuts per minute for 1 to 3 minutes depending on the hardness and the kind of trimmings used. The blended dry ingredients were then added to the Cutter/Mixer and combined with the comminuted trimmings at refrigeration temperatures in the proportion by weight as described in Table 1.

The cutter/mixer was then operated at 3400 rpm during a period of 2 to 3 minutes. After complete mixing of this matrix phase, the fat was added while mixing for a total mixing time of 2 to 3 minutes to obtain a homogeneous phase that was confirmed by microscopic examination. The pH was adjusted to the desired level. The resulting soft solid animal fatty tissue substitute is intended to replace natural animal adipose tissue in ground meat, restructured steaks and other meat applications. The final ground meat products (e.g., burger) containing the novel animal fatty tissue substitute and a desirable proportion of red meat and sustainable red meat alternatives and other essential ingredients were subjected to expert panel evaluation to judge the overall eating characteristics. Moreover, the final ground meat products were also compared side-by-side with respect to the nutritional and environmental impacts and other parameters to show the advantages provided by this disclosure over natural animal adipose tissues and traditional ground beef with different fat levels (e.g., 80% lean and 20% fat).

### Example 2

This example demonstrates the acceptability of hamburgers made with the novel animal fatty tissue substitute (Novel Patties) in comparison to the untreated hamburgers made with 100% ground beef having 80% lean meat and 20% fat (Conventional Patties). An animal fatty tissue substitute was prepared from ingredients in the following proportions according to the process steps as set forth in Example 1.

| Ingredients | (% w/w) |
|---|---|
| Meat blend (turkey and beef) | 83 |
| Gelatin | 4 |
| Oat flour | 2 |
| Plant protein | 1.5 |
| Plasma protein | 2 |
| Flavors | 1 |
| Red beet powder | 0.5 |
| Fat blend (Beef tallow/canola; 50:50) | 6 |
| pH Adjuster | 0 |
| pH | 5.5 |

A meat blend was prepared by mixing ground red and white meat at a weight ratio of 1:1. Then the blend of ground red and white meat was mixed with the novel animal fatty tissue substitute at a weight ratio of 75 meat blend and 25 animal fatty tissue substitute until a homogeneous mixture was obtained. The mixture was subsequently shaped into 4-ounce hamburger patties, designated as novel patties, using a manual hamburger-forming machine. Similarly, conventional patties, made with 100% ground beef, were also shaped into 4-ounce patties using the same manual hamburger-forming machine.

Acceptability of the novel patties was compared with conventional patties using a hedonic test. The novel patties with a total fat level of 12% and conventional patties with total fat level of 20% were cooked on a preheated electric grill at approximately 375° F. for 6 min, then turned over and cooked for another 6 min, to internal temperature of 165° F. as determined using a thermometer. Samples were kept at room temperature until sensory analyses, which followed immediately after cooking. The panel consisted of 20 panelists that like or usually consume beef hamburgers (n=20). Panel members were asked to record their opinions regarding the odor, taste, texture, juiciness, color and overall acceptability of the novel and conventional patties. These attributes were evaluated based on a 6-point hedonic scale, in which 6 represented an extreme like and 1 represented an extreme dislike. The tests were conducted in an enclosed cab with white illumination, and the samples were placed on a white workbench and coded with three random digits. Spring water and unsalted crackers were provided so that the panelists could clean their mouths between samples.

Despite the novel patties having 40% less total fat than the conventional patties, there were unexpectedly no statistically significant differences observed between them in terms of odor, taste, texture, juiciness, color and overall acceptability (Table 2). This example clearly demonstrates the benefits offered by the present disclosure. It achieved a 40% reduction in total fat, including associated artery-clogging saturated fat when compared to conventional patties, yet without compromising the eating and sensory characteristics.

TABLE 2
Sensory Analysis of the novel and conventional hamburger patties

| | | | | | | Overall |
|---|---|---|---|---|---|---|
| Composition | Odor | Taste | Texture | Juiciness | Color | Acceptability |
| Novel Patties | 4.9 ± 1.17 | 4.9 ± 0.79 | 4.3 ± 1.33 | 5.1 ± 0.82 | 4.8 ± 0.9 | 4.9 ± 1.42 |
| (12% fat) | | | | | | |
| Conventional | 5.1 ± 1.34 | 5.1 ± 0.73 | 4.8 ± 1.17 | 4.9 ± 1.03 | 4.9 ± 1.19 | 5.1 ± 1.19 |
| Patties (20% fat) | | | | | | |

Results are expressed as means ± standard deviations. Values rated on a 6-point scale where 6 represented an extreme like and 1 represented an extreme dislike. Means of the same column with different letters are significantly different (P < 0.05).

### Example 3

This example illustrates some nutritional benefits of using the novel animal fatty tissue substitute in the preparation of hamburgers. The animal fatty tissue substitute and hamburger samples were prepared according to the formulation and process described in Example 2.

The comparison is made between hamburgers made with the novel animal fatty tissue substitute (novel patties) with a total fat level of 12% and a reference untreated hamburger made with 100% ground beef with a total fat level of 20% (conventional patties).

The nutritional composition of the uncooked novel patties and conventional patties was analyzed to determine the total fat, saturated fat, calories, and protein content. The results are summarized in FIG. 3.

The use of the novel fat substitute resulted in significant reductions in total fat, saturated fat, and calories, while slightly increasing the protein content. Specifically, the novel patties demonstrated:
A 40% reduction in total fat.
A 54% reduction in saturated fat.
A 25% reduction in calories.
A 9% increase in protein content.

The results indicate that the novel animal fatty tissue substitute effectively reduces the total and saturated fat and calorie content of the hamburgers while increasing the protein content, providing a healthier alternative to conventional formulations without compromising nutritional value or taste, which is another major advantage of the present disclosure over the prior art.

### Example 4

This example illustrates the environmental benefits of hamburgers made with the novel fatty tissue substitute. The animal fatty tissue substitute and hamburger samples were prepared according to the formulation and process described in Example 2. The environmental impacts of hamburgers made with the novel animal fatty tissue substitute (novel patties) with a total fat level of 12% and a reference untreated hamburger made with 100% ground beef with a total fat level of 20% (conventional patties) on the total amount of GHG emission (CO₂), irrigation water and land use were thoroughly examined and quantified. This analysis was conducted using data and figures for different kind of meats extracted from References 2, 4, and 5. The comprehensive results of this assessment are presented in Table 3 for easy reference and comparison.

TABLE 3
Environmental Impact Comparison: Conventional Patty vs. Novel Patty

| | GHG Emissions (Kg CO₂) | Land Use (m²) | Water Use (liters) |
|---|---|---|---|
| 100% Beef (4 oz) | 3.051 | 1.695 to 2.26 | 1695 to 2260 |
| 100% Poultry (4 oz) | 0.678 to 0.791- | 0.339 to 0.452 | 452 to 565 |
| Conventional Patty (4 oz) | 3.051 | 1.695 to 2.26 | 1695 to 2260 |
| Novel Patty (4 oz) | 1.8645 to 1.921 | 1.017 to 1.356 | 1073.5 to 1412.5 |
| Reduction per Patty (4 oz) | 1.13 to 1.1865 | 0.339 to 1.243 | 282.5 to 1186.5 |
| Conventional vs Novel | | | |
| Average Reduction (%) | 38 | 40 | 39 |
| Conventional vs Novel | | | |

Switching from conventional patty to the novel patties offers significant environmental benefits, including a 40% reduction in greenhouse gas emissions, a 40% decrease in land use, and a 39% reduction in water use. The novel patties not only maintain the quality and taste of the conventional patty but also significantly reduces the environmental impact in terms of water usage, land usage, and greenhouse gas emissions. The novel patties made with the novel animal fatty tissue substitute offer a sustainable and eco-friendly alternative to conventional patties, which is a major advantage over the prior art.

### Example 5

This example shows the functionality of hamburger patties is greatly influenced by the pH of the novel animal fatty tissue substitute used in their preparation. The pH of the novel animal fatty tissue substitute was tested at three different levels:
7. Animal fatty tissue substitute A: pH of 3.5
8. Animal fatty tissue substitute B: native pH of 5.4
9. Animal fatty tissue substitute C: pH of 10.5

The animal fatty tissue substitutes were prepared from ingredients in the following proportions according to the process steps as set forth in Example 1 (Table 4).

TABLE 4

| | Animal Fat Substitute | | |
|---|---|---|---|
| Ingredients | A | B | C |
| Meat blend (turkey and beef) (% w/w) | 85 | 85 | 85 |
| Gelatin (% w/w) | 4 | 4 | 4 |
| Plant protein (% w/w) | 1.5 | 1.5 | 1.5 |
| Plasma protein (% w/w) | 2 | 2 | 2 |
| Flavors (% w/w) | 1 | 1 | 1 |
| Red beet powder (% w/w) | 0.5 | 0.5 | 0.5 |
| Fat blend (Beef tallow/canola; | 6 | 6 | 6 |
| 50:50) (% w/w) | | | |
| pH Adjuster | q.s.* | 0 | q.s.* |
| pH | 3.5 | 5.4 | 10.5 |

*q.s. to adjust pH to desired level

A meat blend was prepared by mixing ground red and white meat at a weight ratio of 1:1. Then the blend of ground red and white meat was mixed with each pH adjusted novel animal fatty tissue substitute at a weight ratio of 75 meat blend and 25 animal fatty tissue substitute to form three separate homogeneous mixtures:
10. Mixture A: 75% meat blend 25% animal fatty tissue substitute A
11. Mixture B: 75% meat blend 25% animal fatty tissue substitute B
12. Mixture C: 75% meat blend 25% animal fatty tissue substitute C

Hamburger patties were made from each mixture and shaped into 4-ounce hamburger patties using a manual hamburger-forming machine, and labelled Patties A from Mixture A, Patties B from Mixture B and Patties C from Mixture C.

Patties A, B and C were cooked on a preheated electric grill at approximately 375° F. for 6 min, then turned over and cooked for another 6 min, to internal temperature of 165° F. as determined using a thermometer.

Adjusting the pH of the novel animal fatty tissue substitute can significantly increase the moisture retention and cooking yield of the patties compared to native pH (Table 5).

Cooking Yield: The weight of each sample was measured before and after cooking to determine cooking yield, which was defined as the cooked weight divided by the uncooked weight, then multiplied by 100.

$$Cooking Yield ( \% ) = ( ( Cooked patty weight ) / ( Uncooked patty weight ) ) \times 100$$

Moisture Retention: The moisture retention value represents the amount of moisture retained in the cooked product per 100 g of sample and was determined according to the following equation:

$$Moisture retention ( \% ) = ( \% Yield \times \% moisture in cooked patty ) / 100$$

On either side of the native pH (5.4), the cooking yield and the moisture retention of the hamburger patties significantly increased with pH adjustment. This increase and decrease in pH from the native pH solubilized myofibrillar proteins and enhanced their electrostatic repulsion contributing to better retention of moisture during cooking.

TABLE 5

| | Cooking Yield(%) | Moisture Retention (%) | Texture |
|---|---|---|---|
| Patties A | 78.1^{a} | 44.6^{a} | Soft |
| Patties B | 74.5^{b} | 37.1^{b} | Tender |
| Patties C | 82.6^{c} | 48.4^{c} | Firm |

Different superscripts in the same column (with in each main effect) indicate significant differences (P > 0.05).

This example illustrates the benefits and unexpected results of adjusting the pH of the novel animal fatty tissue substitute used in hamburger patties. By manipulating the pH, meat processors can achieve significant advantages, including improved moisture retention and higher cooking yields. Surprisingly, this method also allows for precise control over the texture, shifting from soft to firm. This unexpected flexibility provides processors with more options in manufacturing, potentially leading to better emulsification in meat batters and firmer gels in specific applications. These improvements can lead to superior product quality and expanded application possibilities for meat processors.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of making an animal fatty tissue substitute for use with a sustainable ground meat or restructured steak product, comprising:
(a) homogenizing meat trimmings or ground meat without added water to break down structure and release cellular components forming a meat or meat blend;
(b) homogenizing the product of step (a) with one or more film-forming agents, fats or fat blends, flavor and color enhancers, and optional binders or bioactive compounds, under vigorous shearing at a temperature below 10° C. and a pH of 3.5-10.5, to form an animal fatty tissue substitute that is devoid of added water;
(c) mixing the animal fatty tissue substitute with red meat, sustainable red-meat alternatives, or combinations thereof at a weight ratio of 0.01:1 to 1:1; and
wherein the fatty tissue substitute defines properties resulting from the conjoint effect of concentration of the fats or fat blends, meat or meat blend, film-forming agents, flavor and color enhancers, temperature, pH, and shearing.

2. The method of claim 1, wherein the meat or meat blend in the fatty tissue substitute is present at 3-95 wt. %.

3. The method of claim 1, wherein the film-forming agents are present at 0.1-30 wt. %.

4. The method of claim 1, wherein the fat or fat blend is present at 1-50 wt. %.

5. The method of claim 1, wherein flavor and color enhancers are present at 0.001-10 wt. %.

6. The method of claim 1, wherein the pH is adjusted to 4-8 using a food-grade acid or base.

7. The method of claim 1, wherein the animal fatty tissue substitute further comprises a bioactive compound selected from the group consisting of preservatives, vitamins, antioxidants, phytochemicals, and combinations thereof.

8. The method of claim 1, further comprising the steps of adding binders selected from cereal proteinaceous materials, non-cereal proteinaceous materials, polysaccharides, and combinations thereof.

9. The method of claim 1, further comprising the steps of adding proteinaceous binders selected from the group consisting of milk solids, egg albumin, blood albumin, meat proteins, plant proteins and combinations thereof.

10. The method of claim 9, wherein the proteinaceous binder is a plant protein derived from a member selected from the group consisting of seeds, legumes, grains, nuts, fruits, vegetables, and combinations thereof.

11. The method of claim 1, further comprising the steps of adding polysaccharide binders selected from the group consisting of maltodextrin, corn syrup, cyclodextrin, carboxymethylcellulose, methyl or hydroxypropyl methylcellulose, xanthan gum, gum tragacanth, alginates, pectin, gum agar, gum karaya, gum Arabic, and combinations thereof.

12. The method of claim 1, wherein the film-forming agent is selected from the group consisting of gelatin, carrageenan, milk whey protein, caseinates, alginate, lecithin, plant proteins, partially gelatinized collagen, and combinations thereof.

13. The method of claim 1, wherein the fats or fats blend comprises vegetable oils, animal fats, omega-3 fatty acids, synthetic lipids, or combinations thereof.

14. A method of making a sustainable ground meat or restructured steak product comprising:
(a) providing a proportion of red meat or sustainable red meat alternatives;
(b) incorporating an animal fatty tissue substitute according to claim 1; and
(c) shaping the finished meat product into patties using traditional burger molds or package in bulk for tacos and other ground meat applications; wherein the restructured steak can be adhered together using a transglutaminase enzyme.

15. The method of claim 14, wherein the red meat is selected from the group consisting of beef, veal, lamb, mutton, bison, pork, venison, and combinations thereof and the sustainable red-meat alternatives are white meats selected from the group consisting of chicken, turkey, duck, goose, fish, rabbit, and fowl, and wherein the weight ratio of red meat to sustainable red meat alternatives is variable from 1:0 to 0:1.

16. The method of claim 14, wherein the sustainable red-meat alternatives are plant-derived proteins selected from the group consisting of soy, pea, gluten, legumes, nuts, grains and combinations thereof.

17. The method of claim 14, wherein the sustainable red-meat alternatives are legumes selected from the group consisting of black beans, soybeans, chickpeas, peas, lentils and combinations thereof.

18. The method of claim 14, wherein the sustainable red-meat alternatives are nuts selected from the group consisting of almonds, walnuts, cashews, pistachios, pecans, hazelnuts, macadamia nuts, Brazil nuts and combinations thereof.

19. The method of claim 14, wherein the sustainable red-meat alternatives are grains selected from the group consisting of quinoa, brown rice, whole wheat, oats, barley, and combinations thereof.

20. The method of claim 14, wherein the sustainable red-meat alternatives further comprise fruits, vegetables, or fungi selected from the group consisting of apple peel, green banana, cherry, pineapple, fruit puree, zucchini, cauliflower, conventional or functional mushrooms and combinations thereof.
